(19) United States
(12) Patent Application Publication
(10) Pub. No.: US 2007/0144658 A1
(43) Pub. Date: Jun. 28, 2007

(54) Manufacturing method of rubber member for tire

(75) Inventors: Youjirou Miki, Kobe-shi (JP); Syuichi Yamamori, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 11/645,646

(22) Filed: Dec. 27, 2006

(30) Foreign Application Priority Data
Dec. 28, 2005 (JP) 2005-379516

(51) Int. Cl. B29D 30/00

(52) U.S. Cl. 156/130; 156/117

(57) ABSTRACT

In a strip wind manufacturing method, the invention provides a manufacturing method of a rubber member for a tire, which can reduce an air remnant in a rubber member. In a manufacturing method of a rubber member for a tire for manufacturing the rubber member having a plurality of overlapping layers for the tire by spirally winding a ribbon-shaped unvulcanized rubber strip around an approximately cylindrical wound body, a torsional direction of a spiral and an axial winding direction are set identical between a first rubber strip forming a first rubber layer in an inner side in a radial direction by spirally winding, and a second rubber strip forming a second rubber layer by spirally winding in an outer side thereof.

### BACKGROUND OF THE INVENTION

1. Field of the Invention

The present invention relates to a strip wind construction method of forming a rubber member for a tire by spirally winding a rubber strip, and more particularly to a manufacturing method of a rubber member for a tire, which can reduce an air remnant in the rubber member.

2. Description of the Related Art

There has been considered to form a rubber member in each of positions of tire, such as a tread rubber, a sidewall rubber or the like by spirally winding a rubber strip made of a material corresponding to a demand characteristic of the rubber member. By the strip wind construction method, a mouth piece of a nozzle and a labor hour of a management can be reduced in comparison with an conventional extrusion molding method of continuously extruding from a mouth piece in a predetermined finish cross sectional shape. Further, it is possible to use a compact rubber extruding machine, and it is possible to achieve a large item small scale production. AS mentioned above, the strip wind construction method (STW method) can improve productivity.

However, in the STW method mentioned above, since the rubber strip is spirally wound, an air reservoir tends to be generated due to a step in a side edge of the rubber strip or the like. This is because the adjacent rubber strips are wound astride the step in the side edge of the previously wound rubber strip. There is an increased risk that the air reservoir is generated between a wound body such as a drum or the like, and a rubber layer spirally wound in an outer side in a radial direction thereof, or between the inner and outer rubber layers in the radial direction in comparison with the conventional one mouth method. Accordingly, Japanese Published patent application 2000-254980 proposes a rubber strip provided with thin lug portions in both side edges, in a rubber strip.

In the proposed structure mentioned above, since both the side edges are provided with the thin step, in the case of forming a diagonal side edge portion, a thickness of an edge step is reduced in comparison with a thickness of a base portion. And an error in an outer peripheral edge between a finish cross sectional shape and an outline shape is reduced. Further, it is possible to achieve an effect to reduce a winding number by the thick base portion. However, it becomes necessary to hold specialized mouth pieces for the extruding machine, and productivity tends to be lowered.

### BRIEF SUMMARY OF THE INVENTION

An object of the present invention is to provide a manufacturing method of a rubber member for a tire, which can reduce an air reservoir even in the case of using a rubber strip having a rectangular cross section in an STW method.

In accordance with the present invention, there is provided a manufacturing method of a rubber member for a tire by spirally winding a ribbon-shaped unvulcanized rubber strip around an approximately cylindrical wound body, wherein the rubber member is formed by spirally winding the rubber strip and employs a plurality of rubber layers overlapping in inner and outer sides in a radial direction, and a torsional direction of a spiral and an axial winding direction are set identical between a first rubber strip forming a first rubber layer in an inner side in a radial direction, and a second rubber strip forming a second rubber layer by spirally winding in an outer side thereof.

Further, in the rubber member, the structure can be made such that materials of the first rubber strip and the second rubber strip are differentiated, the first rubber layer forms a e.g. base rubber layer of a tread rubber, and the second rubber layer forms e.g. a cap rubber layer thereof. The structure can be made such that at least thicknesses are set identical between the first rubber strip and the second rubber strip, and the first rubber strip and the second rubber strip may be wound at the same pitch in an axial winding direction, and with aligned side surfaces.

Accordingly, the present invention can be structured such that spiral directions of the steps generated by the spiral winding are aligned between the inner and outer sides, by setting the torsional direction of the spiral and the axial winding direction identical, and the steps are coincided with each other between the first and second rubber layers. At this time, it is possible to reduce a dead space so as to make them close to each other, and it is possible to suppress the air reservoir.

Further, the structure can be made such that the first rubber strip and the second rubber strip are formed as a wide composite rubber strip in which side edges of the strips are bonded to each other side by side, prior to the winding.

### BRIEF DESCRIPTION OF SEVERAL VIEWS OF THE DRAWING

FIG. 1 is a cross sectional view of a tire showing an example of an embodiment in accordance with the present invention;

FIG. 2 is a cross sectional view exemplifying a rubber member in a state in which first and second rubber layers are overlapped;

FIG. 3 is a cross sectional view exemplifying a state before the second rubber layer is wound around the first rubber layer;

FIG. 4 is a cross sectional view exemplifying a rubber layer in the case of a right torsion rr, and a left axis winding direction dl;

FIG. 5 is a cross sectional view exemplifying a rubber layer in the case of a left torsion rl, and the left axis winding direction dl;

FIG. 6 is a cross sectional view exemplifying a rubber layer in the case of the right torsion rr, and a right axis winding direction dr;

FIG. 7 is a cross sectional view exemplifying a rubber layer in the case of the left torsion rl, and the right axis winding direction dr;

FIG. 8 is a cross sectional view exemplifying a wide rubber strip in which rubber strips are connected in parallel side by side;

FIG. 9 is a cross sectional view showing an example of a conventional winding state of a rubber layer; and

FIG. 10 is a cross sectional view exemplifying an attached state of a sidewall rubber.

### DETAILED DESCRIPTION OF THE INVENTION

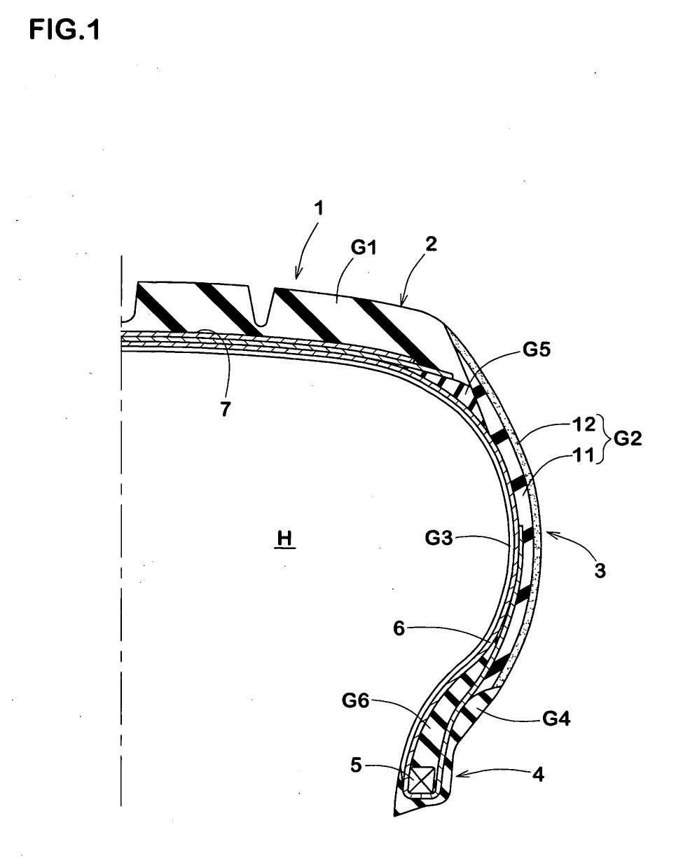

A description will be given of an embodiment in accordance with the present invention with reference to the accompanying drawings. FIG. 1 exemplifies a case that a pneumatic tire is constituted by a radial tire for a passenger car. A tire 1 includes plural kinds of tire rubber members G having different rubber compositions. AS the rubber member, for example, there can be included a tread rubber G1 arranged in a tread portion 2 and forming a ground plane, a sidewall rubber G2 arranged in the sidewall portion 3 and forming a tire outer surface, an inner liner rubber G3 arranged in an inner side of a carcass 6 and surrounding a tire inner cavity H, a clinch rubber G4 arranged in a bead portion 4 and preventing a rim displacement, and a breaker cushion rubber G5 arranged in both ends of a belt layer 7 and protecting an outer end of the belt layer 7. It is possible to include a bead apex rubber G6 extending to an outer side in a radial direction from a bead core 5 of the bead portion 4. The present invention can be preferably adapted to a case that the rubber member G, such as the sidewall rubber G2, and the inner liner rubber G3 which have a uniform thickness portion having an approximately uniform thickness.

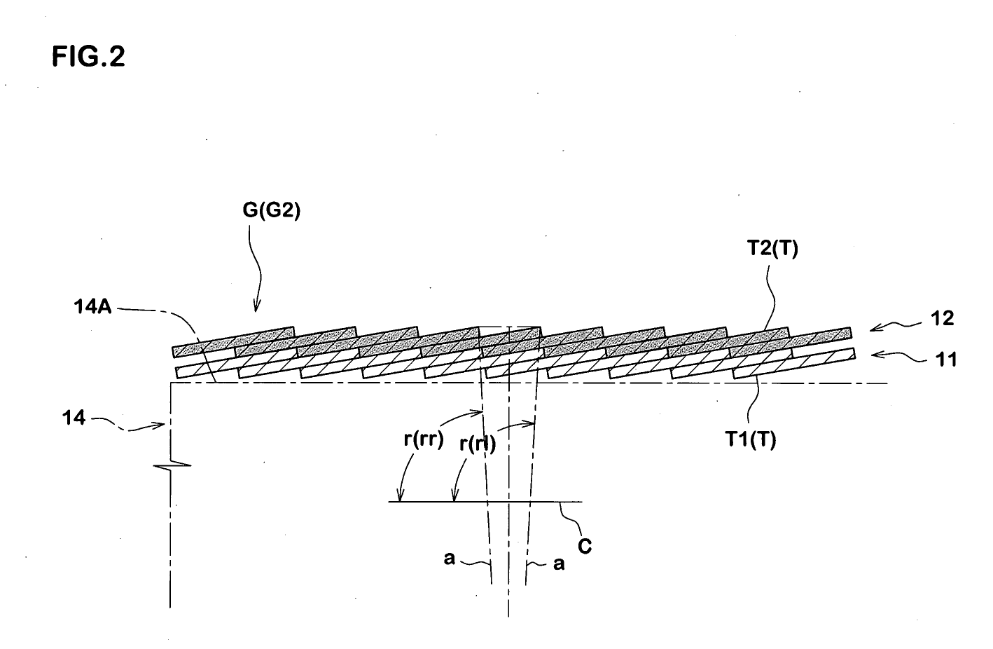

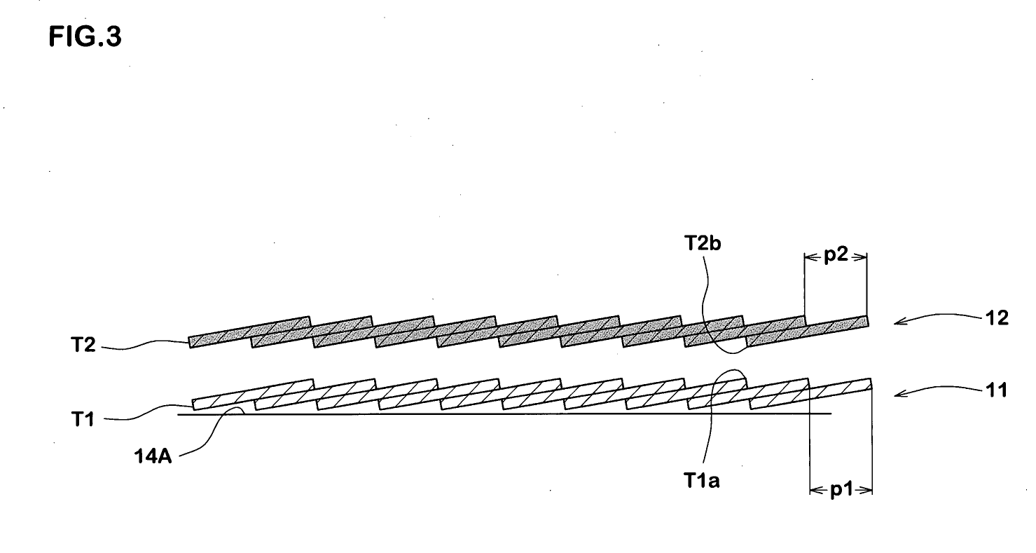

FIGS. 2 and 3 show a case that the rubber member G is constituted as the sidewall rubber G2.

The sidewall rubber G2 comprises a first rubber layer 11 and a second rubber layer 12, and is wound around an outer peripheral surface 14A of a former 14. The first rubber layer 11 is formed by spirally winding a first rubber strip T1 in an inner side in a radial direction, and the second rubber layer 12 is formed by spirally winding a second rubber strip T2 (rubber strip T1, T2 may be generically called as a rubber strip T) in an outer side thereof.

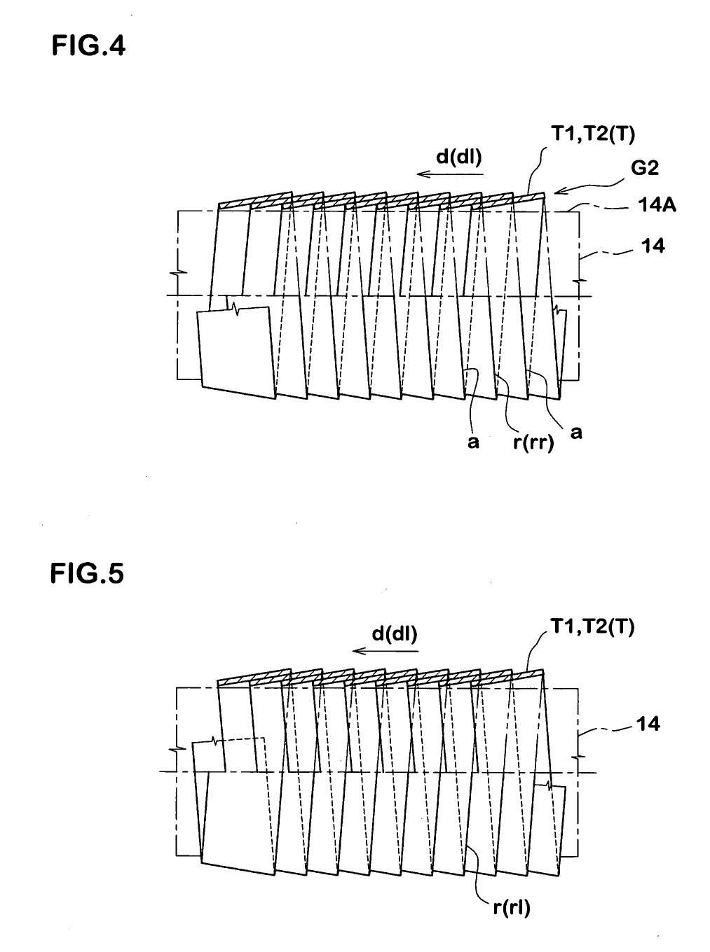

In this case, a torsional direction r of the spiral and an axial winding direction d, as shown in FIGS. 4 and 5, are set to be identical. The torsional direction r of the spiral means, as shown in FIG. 4-7 (in which an upper half is shown by a cross sectional view, and a lower half is shown by a plan view), a torsional direction which a step line a generated by the spiral winding of the rubber strip T forms around a center line C thereof, in the plan view in which the center line C is arranged horizontally. For example, in FIG. 4, when the step line a appearing in the plan view slopes up to the left, the torsional direction r of the spiral twists in accordance with a rightward torsion rr. AS shown in FIG. 5, sloping up to the right is called as a left torsion rl.

Further, the axial winding direction d is called as a right axial winding direction dr in the case that the rubber strip T is spirally wound in a right direction in the drawing with respect to an axial direction of a former 14 around which the rubber strip T is wound, and is called as a left axial winding direction dl in the case that it is in a left direction. Both of FIGS. 4 and 5 correspond to the left axial winding direction dl.

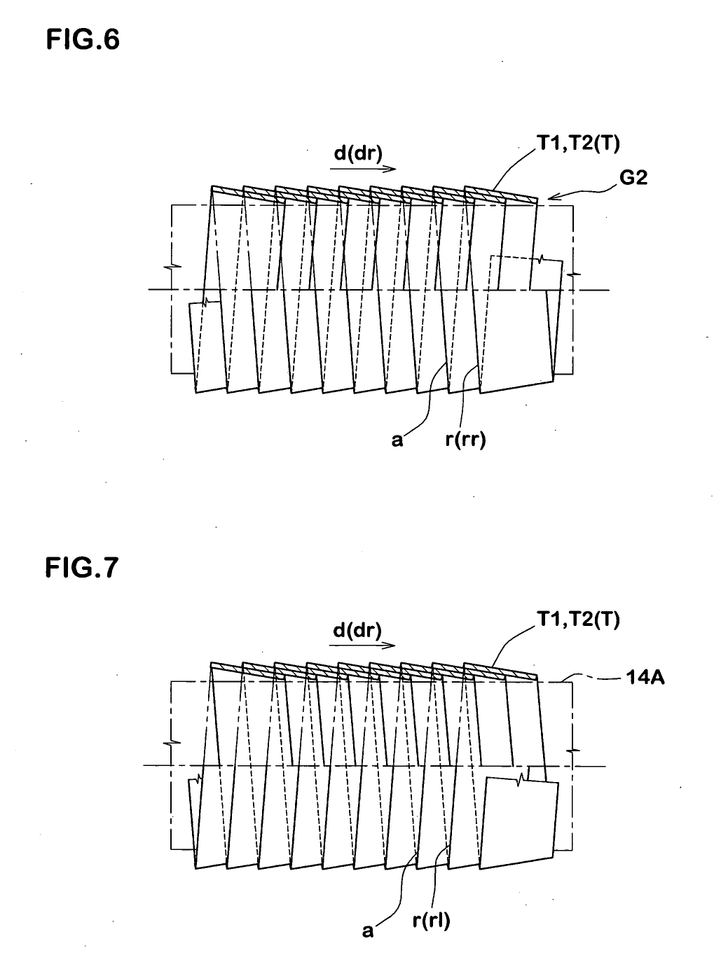

In other words, FIG. 4 shows a case of the rightward torsion rr and the left axial winding direction dl, and FIG. 5 shows a case of the leftward torsion rl and the left axial winding direction dl. In the same manner, FIG. 6 shows a case of the rightward torsion rr and the right axial winding direction dr, and FIG. 7 shows a case of the leftward torsion rl, and the right axial winding direction dr. In this case, FIGS. 4 to 7 shows a diameter of an outer peripheral surface 14A of the former 14 as being abnormally small.

As mentioned above, the torsional directions r and the axial winding directions d of the first and second rubber strips T1 and T2 of the first and second rubber layers 11 and 12 are made identical. Accordingly, it is possible to align the step lines of the both, and it is possible to extrude and discharge the air. Further, it is preferable to set axial winding pitches p1 and p2 of the first and second rubber strips T to be identical. Further, it is preferable to make thicknesses of the first rubber strip T1 and the second rubber strip T2 identical, in the case of being brought into contact by the step line a.

Further, in FIG. 3, at a time of winding the second rubber layer 12, the pitch p2 is made equal to pitch p1, and an upper side edge T1a of the first rubber strip T1 of the wound first rubber layer 11 is aligned with a lower side edge T2b of the second rubber strip T2 in side surfaces. Accordingly, it is preferably possible to suppress an air reservoir generated between the side surfaces of the rubber strips T. In this case, the upper side edge T1a means a side edge forming an upper side due to a slope at a time of winding the rubber strip T1, and the side edge has a side surface. The lower side edge T2b means a side edge forming a lower side due to the slope.

There is included a case that an outward surface in a radial direction of the first rubber strip T1 and an inward surface of the second rubber strip T2 are brought into contact with each other in a state of overlapping in a radial direction. Accordingly it is possible to suppress the air reservoir in conjunction with prevention of the air remnant between the side surfaces.

In the case of manufacturing the rubber member G having the comparatively uniform thickness such as the present embodiment, it is possible to uniformly press the rubber member G to the former by using a comparatively long roller for a pressure forcing. Accordingly, it is possible to make the extrusion of the air easy and it is possible to suppress the generation of the air reservoir.

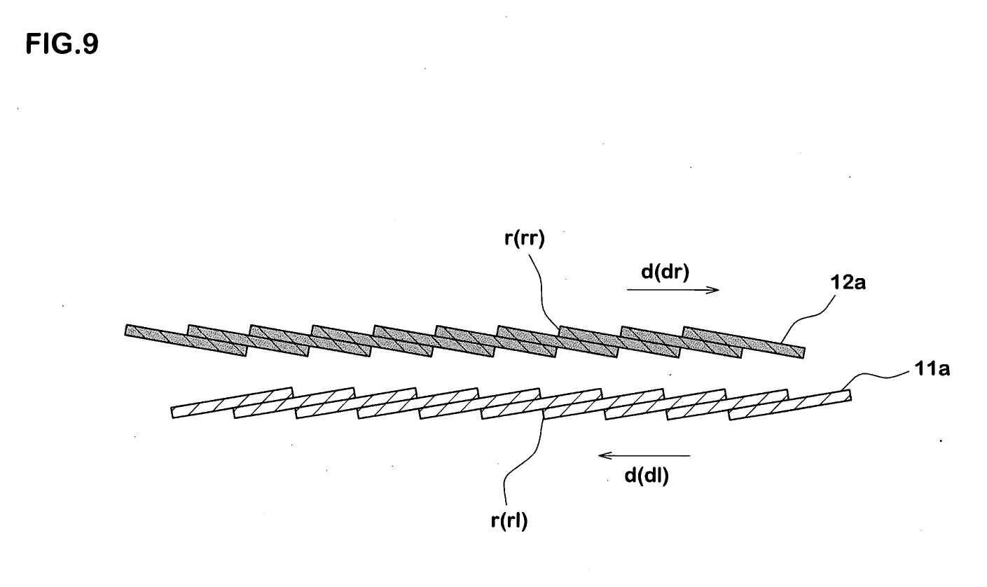

In comparison with this, as shown in FIG. 9, in the case that the torsional direction r of the spiral or the axial winding direction d is different between the first and second rubber layers 11a and 12a, the step line a of the outer peripheral surface of the first rubber layer 11 intersects the step line a in the inner peripheral surface of the second rubber layer 12, and it is impossible to align the directions thereof. As a result, there is considered an inferior effect of preventing the air reservoir near the side surface of the rubber strip T.

Further, in the case of FIG. 9, the direction of the axial winding direction d is set to the left axial winding direction dl in the first rubber layer 11a, and is set to the right axial winding direction dr in the second rubber layer 12a. Further, the torsional direction r is set to the leftward torsion rl in the first rubber layer 11a, and is set to the rightward torsion rr in the second rubber layer 12a. In the case, it reduces the opportunity in which the outward surface in the radial direction of the first rubber strip T1 and the inward surface of the second rubber strip T2 are brought into contact with each other in the state of overlapping in the radial direction, between the first and second rubber layers 11a and 12a. Therefore, it is supposed that the function of preventing the air reservoir between the side surfaces, and suppressing the air reservoir is inferior.

On the other hand, in the case of the present embodiment exemplified by the sidewall rubber G2, a normal sidewall rubber material is used as the inside first rubber layer 11, and a rubber having an excellent crack resistance is used as the outside second rubber layer 12 in an outside air side. As the first rubber strip T1, there is employed a rubber composition in which JISA hardness is not less than 65 and not more than 75, a complex elastic modulus (E*) is not less than 74 kgf/cm² and not more than 90 kgf/cm², and a tangent of the loss angle (tan δ) is not less than 0.25 and not more than 0.35. As the second rubber strip T2, there is employed a rubber composition in which the JISA hardness is not less than 55 and not more than 65, the complex elastic modulus (E*) is not less than 55 kgf/cm² and not more than 60 kgf/cm², and the tangent of the loss angle (tan δ) is not less than 0.20 and not more than 0.25. For example, it is possible to utilize various sidewall rubbers structured such that a carbon is blended to a diene rubber such as a natural rubber, an isoprene rubber, a styrene-butadiene rubber or the like. As mentioned above, it is possible to form the rubber member G made of the rubber corresponding to the nature by employing the different material rubbers for the first and second rubber strips T1 and T2. In this case, the complex elastic modulus (E*) and the tangent of the loss angle (tan δ) are the values obtained by measuring under 70═C, a frequency of 10 Hz, and a dynamic distortion factor of 1% by using a viscous-elasticity spectrometer manufactured by Iwamoto Manufacturing company.

Further, in the rubber strip T mentioned above, a thickness a is set between 0.3 and 1.5 mm, and preferably a width W is set between 15 and 35 mm. In the case that the width W is less than 15 mm or in the case that the thickness t is less than 0.5 mm, a lot of winding frequencies are necessary at a time of finishing a predetermined tread cross sectional shape, and a productivity is lowered. On the contrary, in the case that the width w becomes more than 35 mm or the thickness t becomes more than 1.5 mm, there is a tendency that it is hard to form a delicate cross sectional shape of the rubber member G.

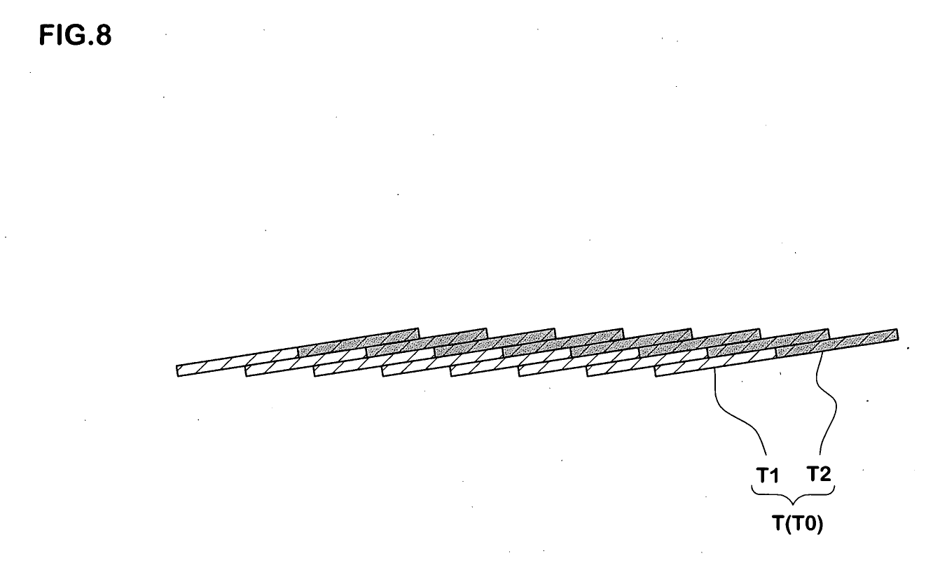

FIG. 8 shows the other embodiment in which the first rubber strip T1 and the second rubber strip T2 are formed as a wide composite integral rubber strip T0 in which the strip side edges are bonded to each other.

Accordingly, it is possible to reduce a head number (an applicator number) for winding and it is possible to form the rubber layers having the different materials in accordance with one winding. Accordingly, it is possible to achieve an adjustment of a tire performance, thereby serving for an improvement of productivity. Further, it is possible to do away with at least the generation of the air reservoir between the first rubber strip T1 and the second rubber strip T2. Besides, there is a limit in the thickness for being thinned at a time of extruding. It solves to connect previously the plurality of the rubber strips T in a width direction side by side. Accordingly, it becomes possible to thin and wide the rubber strip, thereby contributing to the thinning a gauge.

The first and second rubber layers 11 and 12 can be formed by the same rubber material. The side edge is connected during the extrusion, not to extrude the wide strip from one mouth piece. Accordingly, the rubber strip itself can be stabilized, and it is possible to improve the productivity by increasing the rubber quantity for one winding. The plurality of, such as three kinds of strips or the like rubber strips T are formed as the parallel strip side by side, or it is possible to overlap them in a radial direction.

The former 14 of the sidewall rubber G2 shown in FIGS. 2 and 3 is formed in such a manner that the outer peripheral surface 14 A stands in one side in an axial direction so as to be expandable in a disc shape. At this time, it is possible to employ a bladder or the like. The rubber strip T or the like which is wound around the cylindrical former 14 is expanded in the disk shape, at a time of expanding of the former 14, and forms the rubber member G corresponding to the sidewall rubber G2.

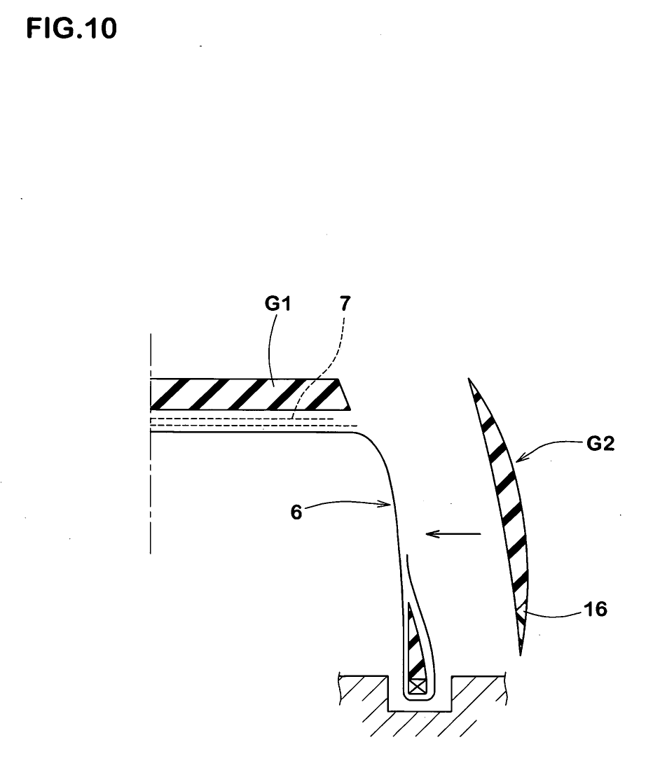

As exemplified in FIG. 10, it is attached to a side surface of the carcass 6 of the raw cover by using a manufacturing apparatus. The raw cover is expanded in a toroid shape, the belt layer 7, the tread rubber G1 and the like are arranged therein, and the raw cover is formed by attaching the disc-shaped rubber member G to the side surface of the carcass 6. Thereafter, the pneumatic tire can be manufactured by vulcanizing the raw cover. In this case, in the expanding aspect, preferably the sidewall rubber G2 is previously integrally formed with the clinch rubber 16 or the like on the other forming drum.

In this case, there is shown the case that the disc-shaped rubber strip T is attached to the side surface of the carcass 6 expanded and deformed in the toroid shape. It is possible to form by directly being wound spirally to the side surface of the carcass 6 around the tire shaft. In the case of the first and second rubber layers having the structure mentioned above, a structure wound in a multiplex manner or partly can be included in the present invention.

The description is given above of the embodiment in accordance with the present invention. The rubber strip is structured such as to have the other cross sectional shapes than the rectangular shape and various materials can be employed in correspondence to the performance demanded in the tire.

The rubber member G shown in FIGS. 2, 3 and 4 to 7, which is in an approximately cylindrical shape, can be adapted as the tread rubber G1. At this time, the rubber member G can be structured such that the material is different between the first rubber strip T1 and the second rubber strip T2, the first rubber layer 11 can form the base rubber layer of the tread rubber G1, and the second rubber layer 12 can form the cap rubber layer of the tread rubber G2.

In addition, the rubber member in accordance with the present invention can be used for forming the inner liner rubber G3 arranged in the inner side of the carcass 6 and surrounding the tire inner cavity H, the clinch rubber G4, the breaker cushion rubber G5, the bead apex rubber or the like, as mentioned above.

Further, the present invention is particularly preferable for the pneumatic tire for the passenger car, however, it goes without saying that the present invention can be applied to various tires such as tires for a motor cycle, a truck, a bus and the like, in addition to the tire for the passenger car.

### EXAMPLES

There is manufactured a pneumatic radial tire for a passenger car on the basis of a tire size of 215/45ZR17 and a specification shown in Tables 1 and 2, and a test is executed about a performance thereof. In this case, a rubber strip C in Table 1 is constituted by a composition rubber strip, and a rubber strip D employs a rubber strip having a double thickness. The air remnant is searched by deconstructing the tire. The productivity is indicated by an indicator in which a comparative example product 2, is set to 100. The larger the index is, the better the productivity is.

TABLE 1

| | Rubber strip | | | |
|---|---|---|---|---|
| | A | B | C | D |
| Cross | Rectan- | Rectan- | Rectan- | Rectan- |
| Sectional | gular | gular | gular | gular |
| shape | | | | |
| Thickness mm | 0.75 | 0.75 | 0.75 | 1.5 |
| Width mm | 18 | 18 | 36 | 18 |
| Material JISA | 70 | 62 | A + B | A (double |
| hardness E* | 81 | 57 | (composition) | thickness) |

TABLE 2

| | | | | | | Comparative | | Comparative |
|---|---|---|---|---|---|---|---|---|
| | Example 1 | | Example 2 | | Example 3 | Example 1 | | Example 2 |
| Rubber layer | First | Second | First | Second | — | First | Second | — |
| Used rubber strip | A | A | A | B | C | A | A | D |

| | | | | | |
|---|---|---|---|---|---|
| Spiral torsional direction | Same | Same | — | Different | Different |
| Axial winding direction | Same | Same | — | Same | Different |
| Difference of pitch between | 5% | 0% | — | — | — |
| first and second rubber | | | | | |
| strips | | | | | |
| End surface alignment | Without | With | — | — | — |
| Air remnant | Without | Without | Without | With | With |
| Productivity | 90 | 90 | 100 | 90 | 100 |

What is claimed is:

1. A manufacturing method of a rubber member for a tire by spirally winding a ribbon-shaped unvulcanized rubber strip around an approximately cylindrical wound body, wherein
said rubber member is constituted by a plurality of rubber layers spirally winding a rubber strip therearound and overlapping in inner and outer sides in a radial direction, and
a torsional direction of a spiral and an axial winding direction are set identical between a first rubber strip forming a first rubber layer in an inner side in a radial direction, and a second rubber strip forming a second rubber layer by spirally winding in an outer side thereof.

2. A manufacturing method of a rubber member for a tire as claimed in claim 1, wherein said rubber member is structured such that materials of said first rubber strip and the second rubber strip are different, the first rubber layer forms a base rubber layer of the tread rubber, and the second rubber layer forms a cap rubber layer of said tread rubber.

3. A manufacturing method of a rubber member for a tire as claimed in claim 1, wherein thicknesses are set identical between said first rubber strip and the second rubber strip, and the first rubber strip and the second rubber strip are wound at the same pitch in an axial winding direction, and in a state of aligning side surface of the upper side edge (T1a) which is at an upper side due to a slope by winding the first rubber strip (T1), and an side surface of the lower side edge (T2b) which is at lower side due to a slope by winding the second rubber strip (T2).

4. A manufacturing method of a rubber member for a tire as claimed in claim 1, wherein said first rubber strip and the second rubber strip are formed as a wide composite rubber strip in which side edges of the strips are bonded to each other, prior to the winding, thereby making a torsional direction of a spiral and an axial winding direction of a first rubber strip forming a first rubber layer in an inner side in a radial direction by winding spirally, and a second rubber strip forming a second rubber layer in an outer side thereof, identical.

5. A manufacturing method of a rubber member for a tire as claimed in claim 1, wherein an outer peripheral surface of said wound body stands at one side in an axial direction, and is expandable in a disc shape, thereby expanding a rubber product in a disc shape.
